(19) United States
(12) Patent Application Publication
(10) Pub. No.: US 2013/0249919 A1
(43) Pub. Date: Sep. 26, 2013

(54) STORAGE MEDIUM HAVING STORED THEREIN INPUT CONTROL PROGRAM, INPUT CONTROL APPARATUS, INPUT CONTROL SYSTEM, AND INPUT CONTROL METHOD

(71) Applicant: Junya OSADA, Kyoto-shi (JP)

(72) Inventor: Junya OSADA, Kyoto-shi (JP)

(73) Assignee: NINTENDO CO., LTD., Kyoto (JP)

(21) Appl. No.: 13/584,986

(22) Filed: Aug. 14, 2012

(30) Foreign Application Priority Data
Mar. 23, 2012 (JP) 2012-066550

(51) Int. Cl. G06T 11/60; G06F 3/041; G09G 5/00

(52) U.S. Cl. 345/472; 345/619; 345/173

(57) ABSTRACT

An input is received from an input apparatus, and a message is input on the basis of the input. Then, a visual attribute of the message when confirmed and displayed on a display apparatus is set by changing the visual attribute in accordance with a length of time during which a confirmation operation of confirming the message continues. When the confirmation operation has ended, the message is confirmed and displayed on the display apparatus on the basis of the visual attribute set at the end of the confirmation operation.

### CROSS REFERENCE TO RELATED APPLICATION

The disclosure of Japanese Patent Application No. 2012-66550, filed on Mar. 23, 2012, is incorporated herein by reference.

### FIELD

The technique shown here relates to a storage medium having stored therein an input control program, an input control apparatus, an input control system, and an input control method, and in particular, relates to a storage medium having stored therein an input control program that, for example, inputs characters based on a user operation, and an input control apparatus, an input control system, and an input control method that, for example, input characters based on a user operation.

### BACKGROUND AND SUMMARY

Conventionally, a service termed “chat” is provided in which users exchange messages as character information via a network. When the chat is conducted, on a display screen of a terminal apparatus used by each user, messages are displayed that have been exchanged using the chat and include a message stated by the user themselves. Then, the user can newly generate and state a message by viewing the messages displayed on the display screen, thereby sequentially updating the messages on the display screen using the stated messages.

When, however, the user attempts to state a message by changing the type of the characters of the message, generally, the user selects a character type for the characters of the message, and decorates the characters of the message to be stated such that the characters are of the selected character type. Then, the user confirms the message to transmit it. Thus, when the user attempts to change the type of the characters of a message to be stated, it is cumbersome to perform the operation of decorating the characters of the message with the type of the characters.

Therefore, it is a main object of an exemplary embodiment to provide a storage medium having stored therein an input control program that enables a user to, when inputting characters, easily decorate the characters, and an input control apparatus, an input control system, and an input control method that enable a user to, when inputting characters, easily decorate the characters.

To achieve the above object, the exemplary embodiment can employ, for example, the following configurations. It should be noted that it is understood that, to interpret the descriptions of the claims, the scope of the claims should be interpreted only by the descriptions of the claims. If there is a conflict between the descriptions of the claims and the descriptions of the specification, the descriptions of the claims take precedence.

In an exemplary configuration of a computer-readable storage medium having stored therein an input control program according to the exemplary embodiment, the input control program is executed by a computer of an apparatus for displaying a message on a display apparatus in accordance with an input. The input control program causes the computer to execute: receiving an input from an input apparatus; inputting a message on the basis of the input; setting a visual attribute of the message when confirmed and displayed on the display apparatus, by changing the visual attribute in accordance with a length of time during which a confirmation operation of confirming the message continues; and performing control so as to, when the confirmation operation has ended, confirm the message and display the confirmed message on the display apparatus on the basis of the visual attribute set at the end of the confirmation operation.

On the basis of the above, a confirmation operation continues in order to confirm a message, thereby changing the visual attribute of the characters of the message to be confirmed. This enables a user to, when inputting characters, easily decorate the characters.

In addition, a size of characters of the message when confirmed and displayed on the display apparatus may be set as the visual attribute by changing the size of the characters in accordance with the length of time during which the confirmation operation continues. When the confirmation operation has ended, the message may be confirmed and displayed on the display apparatus on the basis of the size of the characters set at the end of the confirmation operation.

On the basis of the above, the confirmation operation continues in order to confirm the message, thereby changing the size of the characters of the message to be confirmed. This enables the user to, when inputting a message, easily change the size of the characters of the message.

In addition, the size of the characters may be set by enlarging the size of the characters in accordance with the length of time during which the confirmation operation continues.

On the basis of the above, the confirmation operation continues in order to confirm the message, thereby enlarging the size of the characters of the message to be confirmed. This enables the user to, when inputting a message, easily enlarge the characters of the message. Further, such an operation can be performed in an intuitive manner as the operation of enlarging characters.

In addition, the input control program may further cause the computer to execute presenting an indicator by displaying the indicator on the display apparatus when the visual attribute is changed, the indicator indicating a state of the change.

On the basis of the above, it is possible to use a displayed indicator as a measure of the visual attribute to be confirmed.

In addition, the input control program may further cause transmitting, when the confirmation operation has ended, data representing the visual attribute set at the end of the confirmation operation and the confirmed message, to another apparatus in accordance with the confirmation operation; and acquiring data representing a message confirmed by another apparatus and the visual attribute set for the message. In this case, the message represented by the acquired data may be further displayed on the display apparatus on the basis of the visual attribute represented by the acquired data.

On the basis of the above, it is particularly suitable for use in a chat service in which a character input operation requires immediacy.

In addition, the input apparatus may include at least: an operation button to be subjected to a pressing operation to perform the confirmation operation; and/or an operation unit to be subjected to a touch operation to perform the confirmation operation. In this case, the visual attribute may be set by changing the visual attribute in accordance with a length of time during which the operation button is subjected to the pressing operation, or a length of time during which the operation unit is subjected to the touch operation. The message may be confirmed and displayed on the display apparatus on the basis of the visual attribute set at an end of the pressing operation performed on the operation button, or at an end of the touch operation performed on the operation unit.

On the basis of the above, it is possible to easily change the visual attribute of the characters by holding down an operation button used to confirm an input of a message, or touching an operation section for a long time.

In addition, the exemplary embodiment may be carried out in the forms of an input control apparatus and an input control system that include units for performing the above processes, and an input control method including the above operations.

On the basis of the exemplary embodiment, a confirmation operation continues in order to confirm a message, thereby changing the visual attribute of the characters of the message to be confirmed. This enables a user to, when inputting characters, easily decorate the characters.

These and other objects, features, aspects and advantages of the exemplary embodiment will become more apparent from the following detailed description of the exemplary embodiment when taken in conjunction with the accompanying drawings.

### BRIEF DESCRIPTION OF THE DRAWINGS

FIG. 1 is a diagram showing a non-limiting example of a system including an input control apparatus;

FIG. 2 is a block diagram showing a non-limiting example of the configuration of a terminal apparatus 3 in FIG. 1;

FIG. 3 is a diagram showing a non-limiting example of an image displayed on a display section 35 in FIG. 2;

FIG. 4A is a diagram showing a non-limiting example of characters displayed on the display section 35 when input characters have been confirmed with a pressing time T1;

FIG. 4B is a diagram showing a non-limiting example of characters displayed on the display section 35 when input characters have been confirmed with a pressing time T2;

FIG. 5 is a diagram showing non-limiting examples of main data and programs stored in a storage section 32 in FIG. 2; and

FIG. 6 is a flow chart showing a non-limiting example of the processing performed by the terminal apparatus 3 in FIG. 2.

### DETAILED DESCRIPTION OF NON-LIMITING EXAMPLE EMBODIMENTS

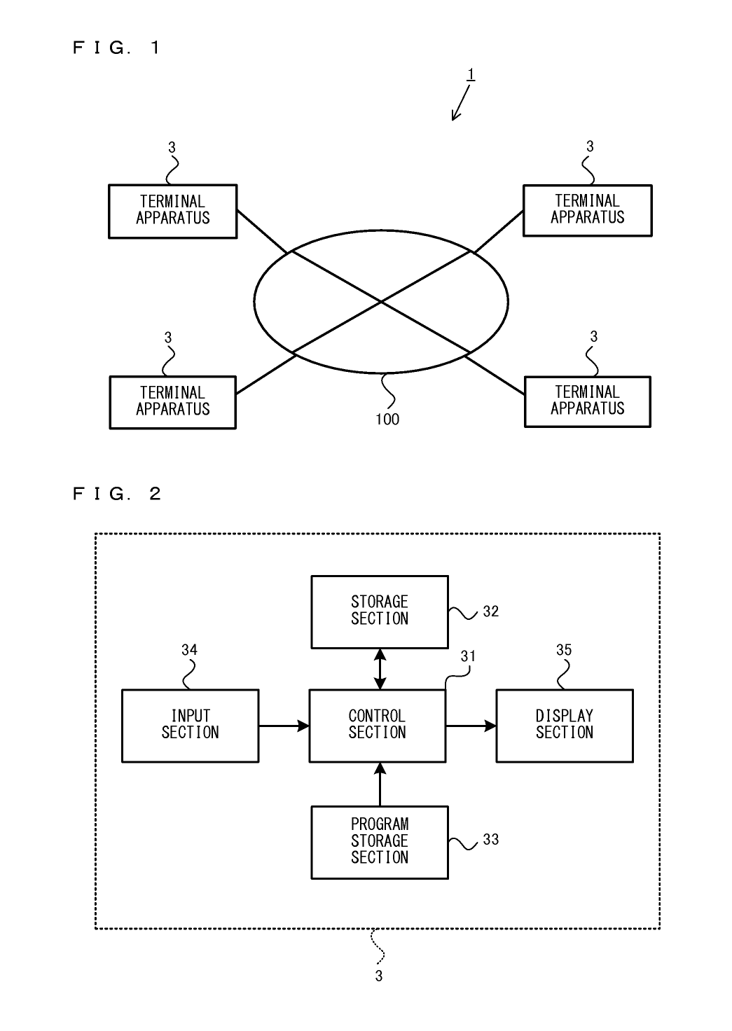

With reference to FIG. 1, a description is given of a system including an input control apparatus according to an exemplary embodiment. As shown in FIG. 1, an input control system 1, which is an example of the system, is constructed by the connection between a plurality of terminal apparatuses 3 via a network 100.

Each of the terminal apparatuses 3 is configured to be connected to the network 100 using wireless or wireless communication. For example, the terminal apparatus 3 can execute a predetermined application (for example, a chat service) in combination with the other terminal apparatuses 3, using a peer-to-peer communication method, a client-server method, or the like. Alternatively, the terminal apparatus 3 may execute the predetermined application by establishing connection with a server (for example, a chat server) via the network 100. For example, the terminal apparatus 3 can execute an input control program stored in a storage medium such as an exchangeable optical disk, or received from another apparatus. The terminal apparatus 3 may be a device such as a general personal computer, a stationary game apparatus, a mobile phone, a handheld game apparatus, or a PDA (Personal Digital Assistant).

Next, with reference to FIG. 2, the terminal apparatus 3 is described. It should be noted that FIG. 2 is a block diagram showing an example of the configuration of the terminal apparatus 3. In FIG. 2, the terminal apparatus 3 includes a control section 31, a storage section 32, a program storage section 33, an input section 34, and a display section 35. The terminal apparatus 3 may be a single apparatus having the above components 31 through 35. Alternatively, the terminal apparatus 3 may include one or more apparatuses containing: an information processing apparatus having at least the control section 31; and another apparatus.

The control section 31 is information processing means (a computer) for performing various types of information processing, and is, for example, a CPU. The control section 31 has the functions of performing as the various types of information processing: the process of performing a chat service in which the terminal apparatus 3 exchanges character information with the other terminal apparatuses 3, and displaying the character information on the display section 35; processing based on the operation performed on the input section 34 by a user; and the like. The above functions of the control section 31 are achieved, for example, as a result of the CPU executing a predetermined program.

The storage section 32 stores various data to be used when the control section 31 performs the above information processing. The storage section 32 is, for example, a memory accessible by the CPU (the control section 31).

The program storage section 33 stores a program. The program storage section 33 may be any storage device (storage medium) accessible by the control section 31. For example, the program storage section 33 may be a storage device provided in the information processing apparatus having the control section 31, or may be a storage medium detachably attached to the information processing apparatus having the control section 31. Alternatively, the program storage section 33 may be a storage device (a server or the like) connected to the control section 31 via a network. The control section 31 (the CPU) may read some or all of the program to the storage section 32 at appropriate timing, and execute the read program.

The input section 34 is an input apparatus that can be operated (subjected to a character input operation, the operation of confirming input characters to make a statement, and the like performed) by the user. The input section 34 may be any input apparatus. For example, as will be apparent later, the terminal apparatus 3 makes it possible to confirm characters, input in accordance with a user operation, to state a message using the confirmed characters in the chat service. In this case, the input section 34 includes, as well as an input apparatus used to input characters, at least a button to be pressed and/or a device to be touched in order to confirm characters. As an example, the above button is formed, for example, of a specific button provided in a keyboard, such as an enter key, or a left button provided in a mouse. As another example, if characters are confirmed by touching via a touch panel an image displayed on a display screen so as to give an instruction to confirm characters, the above device is formed of a touch panel provided so as to cover the display screen. The following descriptions are given using an example where the confirmation of characters as described above is made by pressing an operation button.

The display section 35 displays an image in accordance with an instruction from the control section 31.

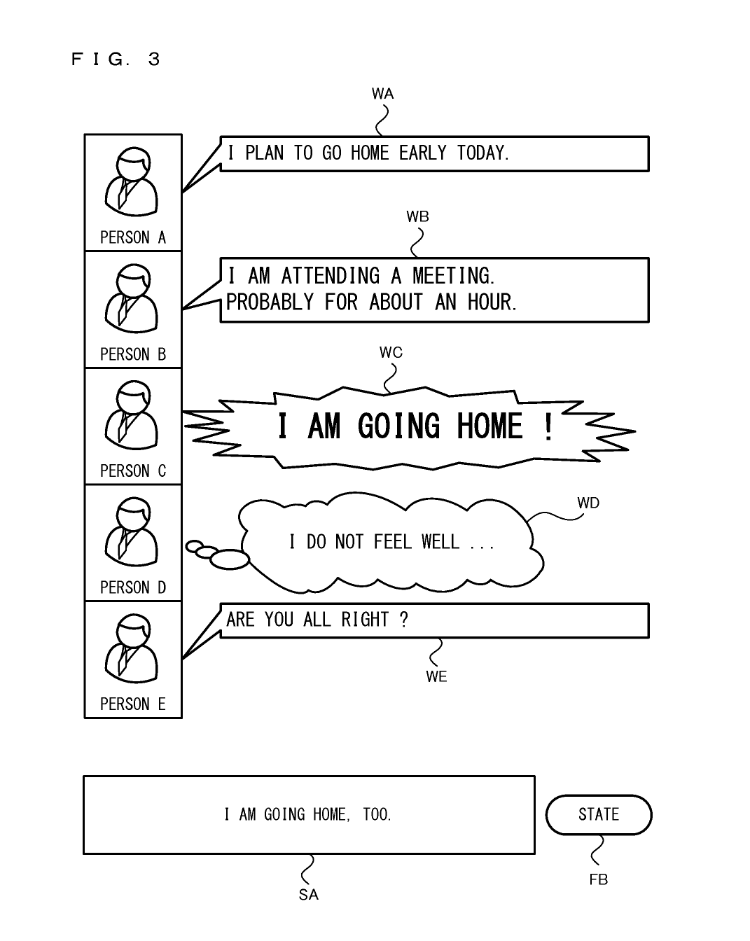

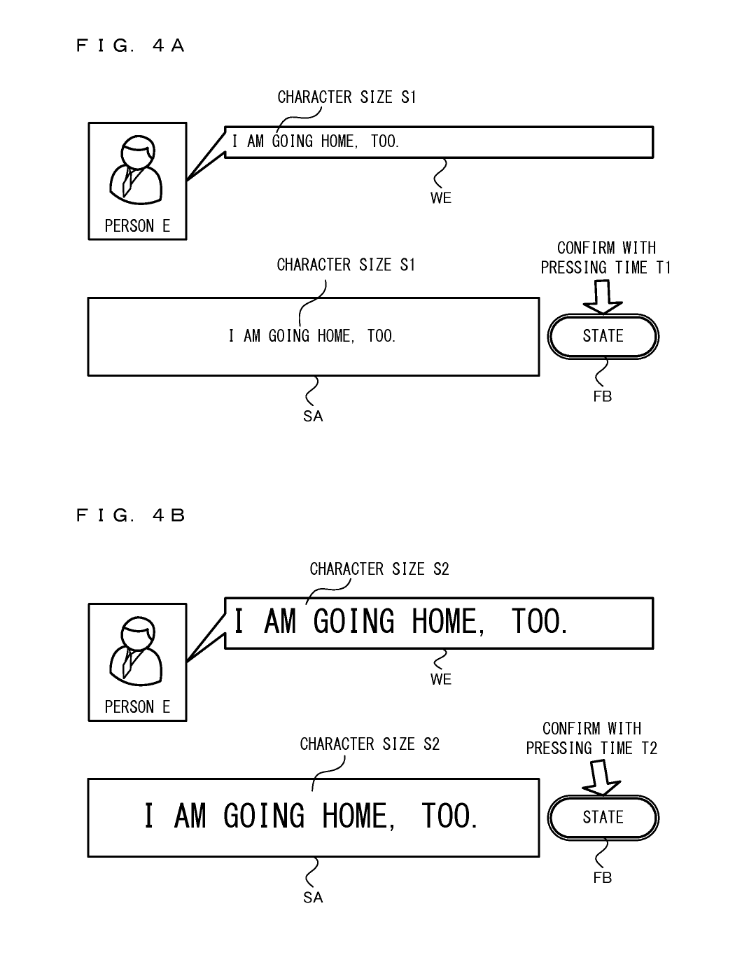

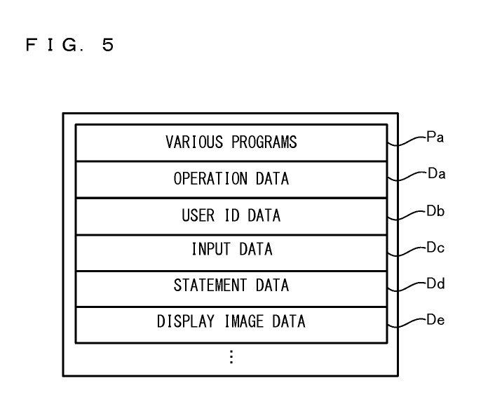

Next, with reference to FIGS. 3, 4A, and 4B, a description is given of an overview of the processing performed by the terminal apparatus 3, before the description of specific processing performed by the terminal apparatus 3. It should be noted that FIG. 3 is a diagram showing an example of an image displayed on the display section 35 of the terminal apparatus 3. FIG. 4A is a diagram showing an example of characters displayed on the display section 35 when a person E has confirmed input characters with a pressing time T1. FIG. 4B is a diagram showing an example of characters displayed on the display section 35 when the person E has confirmed input characters with a pressing time T2. It should be noted that the following descriptions are given using an example of display performed on the display section 35 by executing an input control program according to the exemplary embodiment when a chat service is used in which users of a particular user group exchange messages as character information.

As shown in FIG. 3, on the display section 35 of the terminal apparatus 3 used by a user belonging to the particular user group, the latest messages stated using the chat service by all the users are displayed. In the exemplary embodiment, areas are fixedly set where messages stated by the users are displayed. Specifically, in the example shown in FIG. 3, the users of the particular user group are a person A, a person B, a person C, a person D, and a person E. In this case, the person A is stating, “I plan to go home early today”, as a latest message WA; the person B is stating, “I am attending a meeting. Probably for about an hour”, as a latest message WB; the person C is stating, “I am going home!” as a latest message WC; the person D is stating, “I do not feel well . . . ”, as a latest message WD; and the person E is stating, “Are you all right?” as a latest message WE. Further, in a message creation area SA for inputting characters of a message to be stated, the message “I am going home, too.” is displayed as having been input. In a display area adjacent to the message creation area SA, a statement button FB for transmitting a message written in the message creation area SA to state the message is displayed.

Here, the messages WA through WE are displayed such that the size of the characters representing each message is enlarged in accordance with the length of time (a pressing time T) during which the user presses a button used to confirm the corresponding one of the messages WA through WE to state it (for example, a left button of a mouse used when placing a cursor controlled with the mouse on the statement button FB to select it, and determining the selected statement button FB with the left button of the mouse). As an example, in the example shown in FIG. 3, the messages WA, WD, and WE are displayed in a standard character size because the person A, the person D, and the person E have stated the respective messages by confirming them, each with a pressing time on the basis of which the message is confirmed in the standard character size. Meanwhile, the message WB is displayed in a character size larger than those of the messages WA, WD, and WE because the person B has stated the message by confirming it with a pressing time longer than the pressing time on the basis of which the message is confirmed in the standard character size. Further, the message WC is displayed in a character size larger than that of the message WB because the person C has stated the message by confirming it with a pressing time longer than the pressing time of the person B. As described above, each user adjusts the pressing time with which to press the button used to confirm a message to state it, and thereby can change the size of the characters of the message to be displayed. This makes it possible to state a message by adjusting the size of the characters thereof by an easy operation without increasing the number of the processes of the operation.

When the size of the characters of a message is changed in accordance with the pressing time with which to press the button used to confirm the message (hereinafter occasionally referred to as a “confirmation button”), the size of the characters of the message written in the message creation area SA is changed during the period until the confirmation of the message. This makes it possible to use the message creation area SA as an indicator of the size of the characters of the message to be confirmed.

For example, as shown in FIG. 4A, if the person E presses the confirmation button, using the statement button FB selected as the confirmation button, for a pressing time T1 in order to confirm the message “I am going home, too.” to state it, the message “I am going home, too.” changes in the message creation area SA from a default size to a character size S1 during the period from the start to the end of the pressing time T1. Then, the person E ceases the pressing of the confirmation button at the end of the pressing time T1, thereby confirming the message “I am going home, too.” in the character size Si to state the confirmed message. This statement operation results in causing the message “I am going home, too.” in the character size Si to be displayed as the latest message WE in the statement area for the person E.

Alternatively, as shown in FIG. 4B, if the person E presses the confirmation button for a pressing time T2, which is longer than the pressing time T1, in order to confirm the message “I am going home, too.” to state it, the message “I am going home, too.” changes in the message creation area SA from the default size to a character size S2, which is larger than the character size S1, during the period from the start to the end of the pressing time T2. Then, the person E ceases the pressing of the confirmation button at the end of the pressing time T2, thereby confirming the message “I am going home, too.” in the character size S2 to state the confirmed message. This statement operation results in causing the message “I am going home, too.” in the character size S2 to be displayed as the latest message WE in the statement area for the person E.

As described above, the size of the characters of a message is enlarged in the message creation area SA, whereby the message in the character size set when confirmed is ultimately stated. This allows the user to use the size of the characters changed in the message creation area SA, as an indicator of the size of the characters of the message to be confirmed and displayed, and therefore confirm the message using the indicator as a measure. It should be noted that, in the above descriptions, as the indicator of the size of the characters of the message to be confirmed, the size of the characters of the message displayed in the message creation area SA is changed when displayed. Alternatively, another type of image may be used as the indicator. For example, the size of the characters written in the statement button FB (“state” in the example of FIG. 4A) or the size of the statement button FB itself may be changed during the pressing time, whereby the resulting image may be used as the indicator.

It should be noted that possible examples of the amount of change in the size of the characters in accordance with the pressing time include various forms. For example, the pressing time and the size of the characters may be set so as to have a linear relationship (that is, the amount of change in the size of the characters is constant relative to the pressing time per unit of time). Alternatively, the pressing time and the size of the characters may have a curved relationship, such as a quadratic curve or a cubic curve, where the amount of change in the size of the characters gradually increases relative to the pressing time or where the amount of change in the size of the characters gradually decreases relative to the pressing time, or may have a stepwise and linear relationship. The size of the characters that changes in accordance with the pressing time may be set such that the upper limit of the size of the characters is a predetermined size.

In addition, it is also possible to adjust the amount of change in the size of the characters so that the size of the characters of the message to be stated by confirming it is likely to be set to a standard size. For example, a reference time range is set so as to have a predetermined range of time around the time during which the confirmation button is pressed to perform a general confirmation operation. If the pressing time is within the reference time range, the size of the characters is set to the standard size. If the pressing time is longer than the longest time in the reference time range, the size of the characters is set so as to increase sequentially in accordance with the length of the pressing time. If, on the other hand, the pressing time is shorter than the shortest time in the reference time range, it is set such that the shorter the pressing time, the smaller the size of the characters sequentially become. As described above, the pressing time on the basis of which the size of characters is set to the standard size has a certain range, and also an adjustment is made so as to set the size of the characters to the standard size in the case of a general pressing time. This facilitates the operation of the user when they desire to state a message in a standard character size.

In addition, in the above example of the change in the size of the characters of a message, the longer the pressing time, the larger the size of the characters. The size of the characters of the message to be stated is thus changed such that the longer the pressing time with which to press the button used to confirm the message, the larger the size of the characters of the message. This makes it possible to intuitively change the decoration of the characters of the message. Generally, the statement of a message with large characters is often a simulated representation of the speaker appealing in a loud voice. Thus, the operation of pressing the confirmation button for a relatively long time in such a case often suits the user's mood, and therefore is likely to lead to an intuitive operation. It should be noted that, if such effects are not desired, the size of the characters of the message may be reduced in accordance with the pressing time.

In addition, the above descriptions are given using the example where the size of the characters of a message changes in accordance with the pressing time with which to press the button used to confirm the message. Alternatively, another visual attribute of the characters may change. In the exemplary embodiment, the type of the characters, the decoration of the characters, or the like of a message to be confirmed may be changed as a visual attribute. For example, the brightness, the saturation, or the hue of the color of the characters, or the thickness of the characters may be changed in accordance with the pressing time. Yet alternatively, the design of a speech balloon displayed with the latest message of each user in the statement area may change stepwise in accordance with the pressing time. For example, if the message is confirmed when the pressing time is at or above a predetermined threshold, the speech balloon may be displayed such that, as shown in the message WC in FIG. 3, a decorative frame giving an impression of an explosion surrounds the message of the person who has stated it. It should be noted that, in the specification, the size and the thickness of the characters, the brightness, the saturation, and the hue of the color of the characters, the decorative frame, and the like are collectively referred to as the visual attribute of the characters. It is possible to obtain the effects described above by changing at least one of these visual attributes in accordance with the pressing time when the message is confirmed. Further, the above operation of changing the visual attribute of the characters does not differ, in the procedure of the operation and the number of the processes of the operation, from a conventional operation of inputting characters and a conventional operation of making a statement. Additionally, the above operation is an intuitive operation. Thus, the above operation is particularly suitable for the situation where a character input operation requires immediacy, such as when making a statement in a chat service. The exemplary embodiment, however, can be used not only in a chat service but also to input characters with various tools used in social networks. The exemplary embodiment can also be used to input characters in a general manner when inputting and editing text using a computer system or the like. It should be noted that the decorative frame described above, namely the speech balloon, may be set so as to change in accordance with the type of the button (for example, a shift button or a control button) to be pressed simultaneously with the confirmation button used to confirm the message to state it.

In addition, the above descriptions are given taking as an example the case where the confirmation of characters is made by pressing an operation button. Alternatively, the exemplary embodiment may be applied to operation methods other than such an operation method. In the exemplary embodiment, a confirmation operation of confirming input characters may be any operation so long as the visual attribute of the characters to be displayed on the display section 35 is changed by confirming input characters in accordance with the length of time during which the confirmation operation of confirming the input characters continues.

Next, a detailed description is given of the processing performed by the terminal apparatus 3. First, with reference to FIG. 5, main data used in the processing is described. It should be noted that FIG. 5 is a diagram showing examples of main data and programs stored in the storage section 32 of the terminal apparatus 3.

As shown in FIG. 5, the following are stored in the data storage area of the storage section 32: operation data Da; user ID data Db; input data Dc; statement data Dd; display image data De; and the like. It should be noted that the storage section 32 may store, as well as the data shown in FIG. 5, data and the like necessary for the processing, such as data used in an application to be executed. Further, in the program storage area of the storage section 32, various programs Pa included in the input control program are stored.

The operation data Da is data representing the content of the operation performed on the input section 34.

The user ID data Db is data representing a unique code (a user ID) that enables the identification of the user who is using the terminal apparatus 3.

The input data Dc is data representing a message input by the user of the terminal apparatus 3 to make a statement to the other users. For example, the input data Dc includes character data representing the content of a message stated by the user and character size data, and includes at least data regarding the latest message.

The statement data Dd is data representing messages stated by the users of the other terminal apparatuses 3 and a message stated by the user of the terminal apparatus 3 themselves. For example, the statement data Dd includes character data representing the contents of messages stated by all the users and character size data, and includes at least data regarding the latest messages of all the users. The statement data Dd may also include data representing the types of the decorative frames of speech balloons and data representing other visual attributes of the characters representing the messages of all the users when the characters are displayed.

The display image data De is data for generating an image in which characters and backgrounds based on the messages received from the other users and the message stated by the user of the terminal apparatus 3 themselves are placed, and displaying the image on the display section 35.

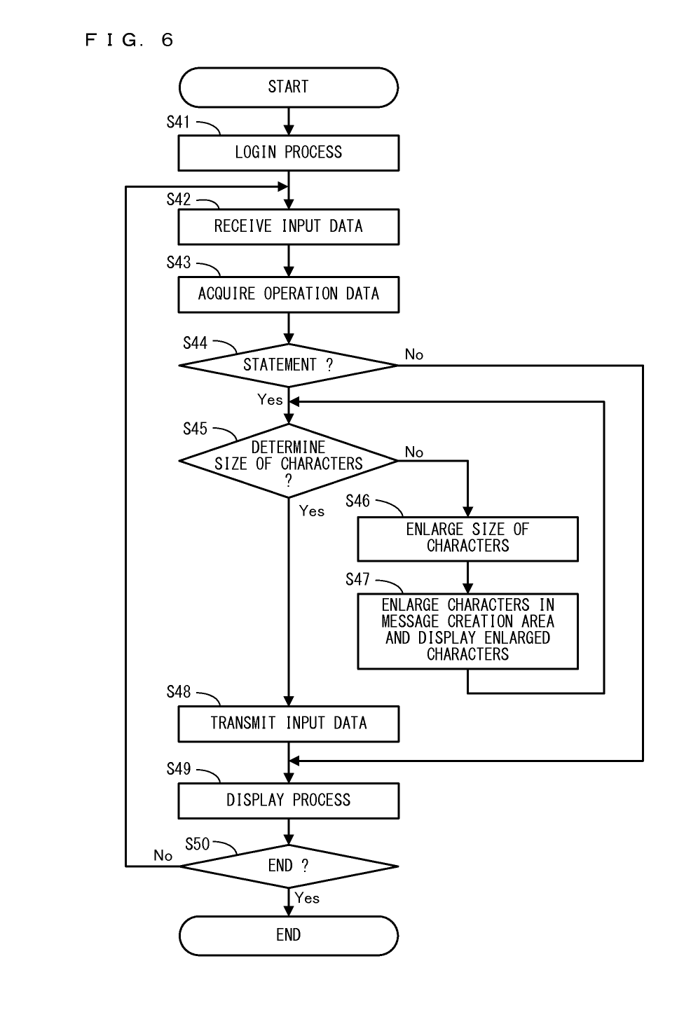

Next, with reference to FIG. 6, a detailed description is given of the processing performed by the terminal apparatus 3. It should be noted that FIG. 6 is a flow chart showing an example of the processing performed by the terminal apparatus 3. Here, in the flow chart shown in FIG. 6, descriptions are given mainly of, in the processing performed by the terminal apparatus 3, the process of exchanging messages among users, and the process of displaying the messages of the users. The detailed descriptions of other processes not directly related to these processes are omitted. Further, in FIG. 6, all the steps performed by the control section 31 are abbreviated as “S”.

The CPU of the control section 31 initializes a memory and the like of the storage section 32, and loads the input control program from the program storage section 33 into the memory. Then, the CPU starts the execution of the input control program. The flow chart shown in FIG. 6 is a flow chart showing the processing performed after the above processes are completed.

It should be noted that the following descriptions of the processing are given using an example where the size of the characters is used as the visual attribute of the characters to be changed, and the indicator of the size is displayed in the message creation area SA. Further, the processes of all the steps in the flow chart shown in FIG. 6 are merely illustrative. Thus, the processing order of the steps may be changed, or another process may be performed in addition to the processes of all the steps, so long as similar results are obtained. Further, in the exemplary embodiment, descriptions are given on the assumption that the control section 31 (the CPU) performs the processes of all the steps in the flow chart. Alternatively, a processor or a dedicated circuit other than the CPU may perform the processes of some or all of the steps in the flow chart.

Referring to FIG. 6, the control section 31 performs the process of logging into the network 100 (step 41), and proceeds to the subsequent step. For example, the control section 31 performs the process of logging into the network 100 using, for example, the user ID represented by the user ID data Db. Then, the application of a chat service provided via the network 100 is started, and the control section 31 performs the process of participating in the chat service. If there are users who have already been participating in the chat service at this time, information indicating that the user of the control section 31 has participated in the chat service may be transmitted to the already participating users.

Next, the control section 31 receives input data from other terminal apparatuses 3 via the network 100 (step 42), and proceeds to the subsequent step. Here, as will be apparent later, each terminal apparatus 3 transmits a user ID for identifying the user who is stating a message, and input data representing the message input by the user. For example, the input data transmitted from each terminal apparatus 3 includes at least character data representing the content of a message, data representing the size of the characters of the message, and a user ID representing the user who has stated the message. The control section 31 updates the statement data Dd using the input data received from the other terminal apparatuses 3. It should be noted that, if it is immediately after the user of the terminal apparatus 3 has participated in the chat service, the input data representing the latest message at that time is transmitted from each of the other terminal apparatuses 3 that have already been participating in the chat service. Thus, the control section 31 receives the transmitted input data, and updates the statement data Dd.

Next, the control section 31 acquires operation data from the input section 34, updates the operation data Da (step 43), and proceeds to the subsequent step. It should be noted that, if the user is inputting the characters of a message to be subsequently stated, the control section 31 updates the input data Dc using the character data based on the input of the characters.

Next, the control section 31 determines whether or not the operation data acquired in the above step 43 is data representing the operation of stating a message (step 44). For example, if an operation button used to perform the operation of stating a message has been pressed, the control section 31 determines that the operation of stating a message has been performed. Then, if the operation data is data representing the operation of stating a message, the control section 31 proceeds to the subsequent step 45. If, on the other hand, the operation data is not data representing the operation of stating a message, the control section 31 proceeds to the subsequent step 49.

In step 45, the control section 31 determines whether or not the operation data acquired in step 43 is data representing the operation of determining the size of the characters of the message. For example, if the pressing of the operation button used to perform the operation of stating the message has been ceased, the control section 31 determines that the operation data is data representing the operation of determining the size of the characters. If the pressing of the operation button is continuing, the control section 31 determines that the operation data is not data representing the operation of determining the size of the characters. Then, if the above operation data is data representing the operation of determining the size of the characters, the control section 31 proceeds to the subsequent step 48. If, on the other hand, the above operation data is not data representing the operation of determining the size of the characters, the control section 31 proceeds to the subsequent step 46.

In step 46, the control section 31 enlarges the size of the characters of the message to be stated, updates the input data Dc, and proceeds to the subsequent step. It should be noted that the method of changing the size of the characters of the message is similar to that described using FIG. 3 and the like, and therefore is not described in detail here. In the example shown here, the input data Dc includes data representing the size of the characters of the message. Alternatively, the input data Dc may include data representing another parameter that enables the setting of the size of the characters. For example, the input data Dc may include data representing the length of time during which the operation button to be pressed to enlarge the size of the characters is pressed (that is, the pressing time T), instead of data representing the size of the characters. In this case, when a message is confirmed and displayed, the size of the characters of the message may be set on the basis of data representing the pressing time set for the message, and the message may be displayed in accordance with the set size of the characters.

Next, on the basis of the input data Dc, the control section 31 enlarges the characters to be displayed in the message creation area SA, displays the enlarged characters on the display section 35 (step 47), returns to the above step 45, and repeats the process thereof.

On the other hand, in step 48, the control section 31 transmits, to the other terminal apparatuses 3, input data representing the message subjected to the operation of stating it, and proceeds to the subsequent step 49. For example, the control section 31 transmits the character data representing the latest message stored in the input data Dc and the character size data, together with the user ID of the user of the terminal apparatus 3 themselves represented by the user ID data Db, to the other terminal apparatuses 3 participating in the same chat service. Further, the control section 31 updates the statement data Dd corresponding to the message stated by the user of the terminal apparatus 3 themselves, using the character data and the character size data.

In step 49, the control section 31 causes the latest messages of all the users including the user of the terminal apparatus 3 themselves to be displayed on the display section 35 on the basis of the statement data Dd, and proceeds to the subsequent step. For example, the control section 31 causes all the messages represented by the statement data Dd to be displayed on the display section 35 in the character sizes based on the statement data Dd. As is apparent from the above descriptions of steps 44 through 48, while the user keeps pressing the operation button to be pressed to confirm (state) a message, the processes of the above steps 45 through 47 are repeated. Then, the processes of the steps 45 through 47 are repeatedly performed, thereby gradually enlarging the size of the characters of the message to be stated. Thereafter, the end of the pressing of the operation button confirms the size of the characters, and the message of the user of the terminal apparatus 3 in the confirmed character size is transmitted to the other terminal apparatuses 3, while the message of the user of the terminal apparatus 3 themselves is displayed also on the display section 35 of the terminal apparatus 3.

Next, the control section 31 determines whether or not to end the processing (step 50). Examples of conditions for ending the processing include: the satisfaction of the conditions under which the processing is ended (for example, time is over); the satisfaction of the conditions under which the game is completed; and the fact that the user has performed the operation of ending the processing. If the processing is not to be ended, the control section 31 returns to the above step 42, and repeats the process thereof. If the processing is to be ended, the control section 31 ends the processing indicated in the flow chart.

It should be noted that the above descriptions are given using the example where the terminal apparatus 3 performs the input control process. Alternatively, another apparatus may perform at least some of the processing steps of the input control process. For example, if the terminal apparatus 3 is further configured to communicate with another apparatus (for example, a server), the other apparatus may cooperate to perform the processing steps of the input control process. As a possible example, another apparatus may perform the process of aggregating statement data and changing the states of the visual attributes, and the terminal apparatus 3 may receive, from the other apparatus, data representing messages of all the users, and cause all the messages to be displayed on the display section 35 of the terminal apparatus 3. Another apparatus may thus perform at least some of the processing steps in the input control process, which enables an input control process similar to that described above. Further, the input control process described above can be performed by a processor or the cooperation of a plurality of processors, the processor and the plurality of processors contained in an input control system including at least one information processing apparatus.

In addition, the input control program may be supplied to the terminal apparatus 3 not only through an external storage medium, but also through a wired or wireless communication link. Further, the program may be stored in advance in a non-volatile storage device included in the terminal apparatus 3. It should be noted that examples of an information storage medium having stored therein the program may include CD-ROMs, DVDs, optical disk storage media similar to these, non-volatile memories, flexible disks, hard disks, magneto-optical disks, and magnetic tapes. Alternatively, an information storage medium having stored therein the program may be a volatile memory for storing the program. It can be said that such a storage medium is a storage medium readable by a computer or the like. For example, it is possible to provide the various functions described above by causing a computer or the like to load a program from the storage medium and execute it.

While some exemplary systems, exemplary methods, exemplary devices, and exemplary apparatuses have been described in detail above, the above descriptions are merely illustrative in all respects, and do not limit the scope of the systems, the methods, the devices, and the apparatuses. It is needless to say that the systems, the methods, the devices, and the apparatuses can be improved and modified in various manners without departing the spirit and scope of the appended claims. It is understood that the scope of the systems, the methods, the devices, and the apparatuses should be interpreted only by the scope of the appended claims. Further, it is understood that the specific descriptions of the exemplary embodiment enable a person skilled in the art to carry out an equivalent scope on the basis of the descriptions of the exemplary embodiment and general technical knowledge. It should be understood that, when used in the specification, the components and the like described in the singular with the word “a” or “an” preceding them do not exclude the plurals of the components. Furthermore, it should be understood that, unless otherwise stated, the terms used in the specification are used in their common meanings in the field. Thus, unless otherwise defined, all the jargons and the technical terms used in the specification have the same meanings as those generally understood by a person skilled in the art in the field of the exemplary embodiment. If there is a conflict, the specification (including definitions) takes precedence.

As described above, the exemplary embodiment is useful as, for example, an input control program, an input control apparatus, an input control system, an input control method, and the like in order, for example, to input characters.

What is claimed is:

1. A computer-readable storage medium having stored therein an input control program to be executed by a computer of an apparatus for displaying a message on a display apparatus in accordance with an input, the input control program causing the computer to execute:
receiving an input from an input apparatus;
inputting a message on the basis of the input;
setting a visual attribute of the message when confirmed and displayed on the display apparatus, by changing the visual attribute in accordance with a length of time during which a confirmation operation of confirming the message continues; and
performing control so as to, when the confirmation operation has ended, confirm the message and display the confirmed message on the display apparatus on the basis of the visual attribute set at the end of the confirmation operation.

2. The computer-readable storage medium having stored therein the input control program according to claim 1, wherein
a size of characters of the message when confirmed and displayed on the display apparatus is set as the visual attribute by changing the size of the characters in accordance with the length of time during which the confirmation operation continues, and
when the confirmation operation has ended, the message is confirmed and displayed on the display apparatus on the basis of the size of the characters set at the end of the confirmation operation.

3. The computer-readable storage medium having stored therein the input control program according to claim 2, wherein
the size of the characters is set by enlarging the size of the characters in accordance with the length of time during which the confirmation operation continues.

4. The computer-readable storage medium having stored therein the input control program according to claim 1, the input control program further causing the computer to execute
presenting an indicator by displaying the indicator on the display apparatus when the visual attribute is changed, the indicator indicating a state of the change.

5. The computer-readable storage medium having stored therein the input control program according to claim 1, the input control program further causing the computer to execute:
transmitting, when the confirmation operation has ended, data representing the visual attribute set at the end of the confirmation operation and the confirmed message, to another apparatus in accordance with the confirmation operation; and
acquiring data representing a message confirmed by another apparatus and the visual attribute set for the message, wherein
the message represented by the acquired data is further displayed on the display apparatus on the basis of the visual attribute represented by the acquired data.

6. The computer-readable storage medium having stored therein the input control program according to claim 1,
the input apparatus including at least:
an operation button to be subjected to a pressing operation to perform the confirmation operation; and/or
an operation unit to be subjected to a touch operation to perform the confirmation operation, wherein
the visual attribute is set by changing the visual attribute in accordance with a length of time during which the operation button is subjected to the pressing operation, or a length of time during which the operation unit is subjected to the touch operation, and
the message is confirmed and displayed on the display apparatus on the basis of the visual attribute set at an end of the pressing operation performed on the operation button, or at an end of the touch operation performed on the operation unit.

7. An input control apparatus for displaying a message on a display apparatus in accordance with an input, the input control apparatus comprising:
an input reception unit for receiving an input from an input apparatus;
a message input unit for inputting a message on the basis of the input;
an attribute setting unit for setting a visual attribute of the message when confirmed and displayed on the display apparatus, by changing the visual attribute in accordance with a length of time during which a confirmation operation of confirming the message continues; and
a display control unit for, when the confirmation operation has ended, confirming the message and displaying the confirmed message on the display apparatus on the basis of the visual attribute set at the end of the confirmation operation.

8. An input control system, including a plurality of apparatuses configured to communicate with each other, for displaying a message on a display apparatus in accordance with an input, the input control system comprising:
an input reception unit for receiving an input from an input apparatus;
a message input unit for inputting a message on the basis of the input;
an attribute setting unit for setting a visual attribute of the message when confirmed and displayed on the display apparatus, by changing the visual attribute in accordance with a length of time during which a confirmation operation of confirming the message continues; and
a display control unit for, when the confirmation operation has ended, confirming the message and displaying the confirmed message on the display apparatus on the basis of the visual attribute set at the end of the confirmation operation.

9. An input control method to be performed by a processor or a cooperation of a plurality of processors, the processor and the plurality of processors contained in a system including at least information processing apparatus for displaying a message on a display apparatus in accordance with an input, the input control method comprising:
receiving an input from an input apparatus;
inputting a message on the basis of the input;
setting a visual attribute of the message when confirmed and displayed on the display apparatus, by changing the visual attribute in accordance with a length of time during which a confirmation operation of confirming the message continues; and
performing control so as to, when the confirmation operation has ended, confirm the message and display the confirmed message on the display apparatus on the basis of the visual attribute set at the end of the confirmation operation.
